(19) United States
(12) Patent Application Publication
(10) Pub. No.: US 2010/0274731 A1
(43) Pub. Date: Oct. 28, 2010

(54) Method and System for Recording Real Estate Transactions

(76) Inventor: George Tsitsis, Victoria (AU)

Correspondence Address: LETHAM LAW FIRM, LLC, 914 N. TUCANA LANE, GILBERT, AZ, 85234, US

(21) Appl. No.: 12/301,030

(22) PCT Filed: May 16, 2007
(86) PCT No.: PCT/AU2007/000650

§ 371 Date: Nov. 16, 2008

(30) Foreign Application Priority Data
May 16, 2006 (AU) 2006902590

(51) Int. Cl. G06Q 50/00; G06Q 10/00; G06Q 30/00; H04N 5/00; H04N 5/91

(52) U.S. Cl. 705/305; 705/316; 386/117; 386/69; 386/E05.003

(57) ABSTRACT

The present invention provides a system for recording real estate transactions including, at least one buyer and at least one seller and/or at least one real estate agent, at least one property for sale, at least one real estate transaction between said buyer and seller/real estate agent and a recording means for capturing at least one footage of said transaction whereby the system for recording real estate transactions provides a means of enabling a person to have a visual and/or audio record of all aspects of a real estate transaction.

### FIELD OF THE INVENTION

The invention relates to the buying and selling of real estate, and in particular, to a method and system for recording real estate transactions which provides a means of enabling a person to have a visual and/or audio record of all aspects of a real estate transaction recorded in real-time which can be easily stored and referred to at a later stage.

Whilst the invention may be applied to the recordal of any legal transaction, for convenience sake it shall be described herein in terms of a method and system for recording real estate transactions.

### BACKGROUND TO THE INVENTION

The buying process for real estate involves a number of different steps including; consultation with a real estate agent, viewing properties, selecting a home and making an offer to purchase, acceptance of contracts, scheduling inspections, property appraisal, view inspection reports and making any necessary repair requests, final inspection, depositing initial earnest money and remaining balance of downpayment, signing closing documents and loan papers and receiving keys. Consequently, the purchase of property can be quite daunting for a buyer particularly due to the binding legalities and large investment involved.

Accordingly, a number of methods and systems having been developed to assist a buyer and attempt to simplify the buying process. Numerous online websites have been developed which allow descriptions of the property, pictures and even virtual tours of the property to be made available to a buyer in order to assist a buyer in narrowing their search without wasting time inspecting the property and providing a means for viewing a property where a buyer is unable to physically inspect a property despite it remaining difficult to obtain a true feel for the property.

In addition, there a number of inspection and investigation services which are independently provided and are adapted to enable a potential buyer to have a qualified unbiased third party conduct an inspection or investigation of the property to provide an assessment for any physical or structural defects on the property or an evaluation of the surrounding area and provide the buyer with a report of the findings.

The prior art fails to address the need for a method and system which allows the various steps of the buying process to be recorded and provided to a buyer as a formal record of the purchase capable of providing evidence supplementary to the actual sales contract. In many instances, a buyer will view a property and be advised that certain fittings/items will be sold with the property enticing the buyer to make a purchase however, when the buyer has finalised the purchase and moved into the property these items have been removed. Often the agreement to include these items may be purely verbal and there may not be any record of these items being present if they are not depicted in the photos obtained by the real estate agent.

It is an object of the present invention to overcome or substantially ameliorate the disadvantages of the prior art by providing a method and system for recording real estate transactions which provides a means of enabling a person to have a visual and/or audio record of all aspects of a real estate transaction recorded in real-time which can be easily stored and referred to at a later stage

### SUMMARY OF THE INVENTION

In a first aspect, the present invention provides a system for recording real estate transactions including;

at least one buyer and at least one seller and/or at least one real estate agent;

at least one property for sale;

at least one real estate transaction between said buyer and seller/real estate agent; and

a recording means for capturing at least one footage of said transaction whereby the system for recording real estate transactions provides a means of enabling a person to have a visual and/or audio record of all aspects of a real estate transaction.

The real estate agent is preferably a qualified/registered real estate agent who has been engaged to act on behalf of a buyer and/or seller for the purchase and/or sale of a property.

Preferably, the recording means is a recording service, which is provided by the real estate agent/company or any other suitable independent company or individual capable of providing such a service, having a recording device. The recording device is preferably in the form of a portable video recorder/handycam or the like which is capable of recording both audio and video formats.

It is preferred that the video and/or audio footage captured by the recording means and/or copies of documents is able to be recorded in a storable format onto a recordable media which enables unlimited playback of recorded material at a later stage. The recordable media may preferably be a DVD, CD, video tape or the like. The footage is preferably stored in segments/chapters to enable easy navigation and retrieval of the desired footage.

Preferably, at least one report is provided to the buyer containing an itemised list of household contents and fittings.

In a second aspect, the invention provides a method for recording real estate transactions comprising the following steps;

providing at least one buyer and at least one seller;

providing at least one property for sale;

providing at least one real estate transaction between said buyer and seller/real estate agent;

providing a recording means for capturing at least one footage of said transaction whereby the system for recording real estate transactions provides a means of enabling a person to have a visual and/or audio record of all aspects of a real estate transaction.

The entire inspection of the property is preferably recorded showing each room and covering every detail of the property. The buyer is preferably able to have confirmation of inclusions and/or repairs and maintenance requirements recorded at each inspection.

Preferably, the footage of the real estate transaction and/or electronic copies of any documents are recorded on a recordable media and given to the buyer.

It is preferred that the buyer is further provided with at least one report containing an itemised list of household contents and fittings.

In order that the invention may be more readily understood we will describe by way of non-limiting example of a specific embodiment thereof.

### BRIEF DESCRIPTION OF THE DRAWING FIGURES

FIG. 1 shows the system for recording real estate transactions according to a preferred embodiment of the invention.

FIG. 2 shows the method for recording real estate transactions according to a preferred embodiment of the invention.

### DESCRIPTION OF A PREFERRED EMBODIMENT OF THE INVENTION

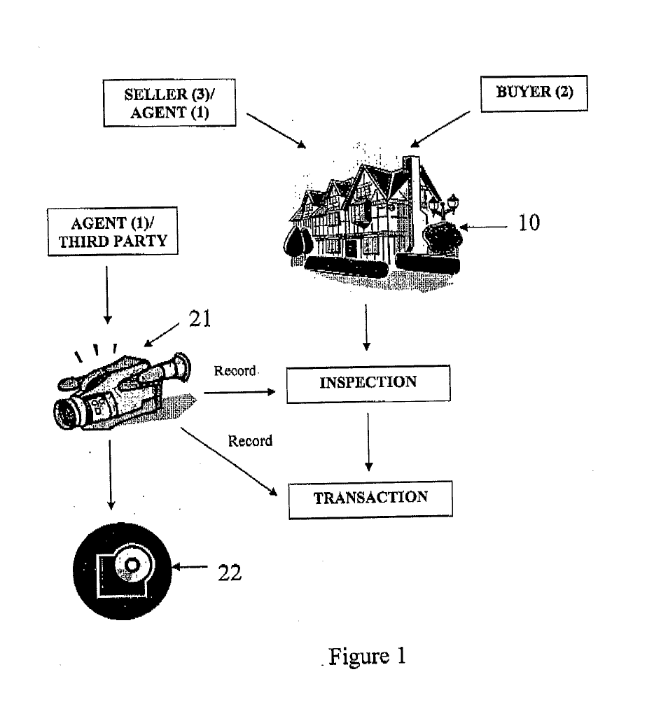

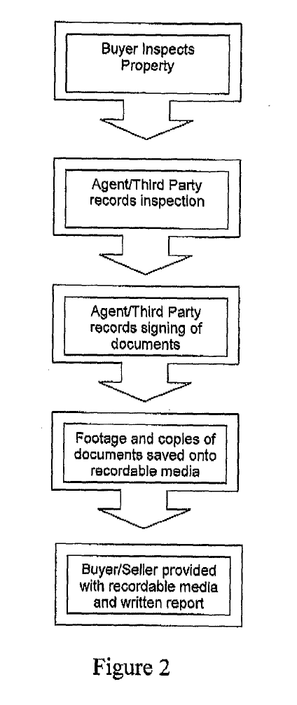

FIGS. 1 to 2 show the method and system for recording real estate transactions according to a preferred embodiment of the invention.

In this preferred embodiment, the invention provides a method and system for recording real estate transactions which provides a means of enabling a person to have a visual record of all aspects of a real estate transaction recorded in real-time which can be easily stored and referred to at a later stage.

The system for recording real estate transactions preferably has provided at least one real estate agent 1. The real estate agent is preferably a qualified/registered real estate agent who has been engaged to act on behalf of a buyer and/or seller for the purchase and/or sale of a property. The system preferably has at least one buyer 2 wishing to purchase a property 10 and at least one seller 3 who is selling a property 10.

The system for recording real estate transactions preferably has provided a recording means. The recording means is preferably a recording service which is provided by the real estate agent/company 1 or any other suitable independent company or individual capable of providing such a service. The recording service may preferably have provided at least one recording device 21. The recording device 21 is preferably in the form of a video recorder/handycam or the like which is capable of recording both audio and video formats. However, it is envisaged that any other suitable device may also be employed, particularly as new technological devices are made. The recording device 21 is preferably portable so that it can be taken to different locations and be unobtrusive in the recording process. In a further embodiment, it is envisaged that the recording means may preferably be a recording device 21 which does not require an additional recording service.

The system preferably has provided at least one recordable media 22 which is adapted to enable the video and/or audio footage captured by the recording device 21 to be recorded onto a storable format which enables unlimited playback of recorded material at a later stage. The recordable media 22 is preferably a DVD. However, it is envisaged that any suitable recordable media such as a video tape, CD or the like may also be utilised. It is envisaged that the video and/or audio footage may be recorded directly onto the recordable media 22 and/or transferred/saved onto the media at a later stage. The recordable media 22 is preferably adapted to store the any video and/or audio footage (not shown) and/or any other related information. The video and/or audio footage is preferably stored in segments/chapters (not shown) provided on the DVD. There may preferably be provided a menu (riot shown) which details or displays the various segments/chapters and allows a person to easily locate and refer to the various items/rooms or places viewed and stored on the DVD at a later stage.

The method of recording real estate transactions preferably provides at least one seller 3 engaging a real estate agent 1 to sell their property and at least one buyer 2 approaching a real estate agent 1 with respect to the purchase of an advertised property 10. The method of recording real estate transactions preferably involves the parties going through the various steps of a real estate transaction which may include, but not be limited to, the following:
consultation with a real estate agent;
viewing properties;
selecting a home and making an offer to purchase;
acceptance of contracts;
scheduling inspections;
property appraisal;
viewing inspection reports and making any necessary repair requests;
final inspection;
depositing initial earnest money and remaining balance of downpayment; and
signing closing documents and loan papers and receiving keys.

The method preferably involves each step or part of the real estate transaction, whether it be a written and/or verbal contract or agreement or an actual inspection, being recorded in real-time with a recording device 21. When the buyer 2 inspects the property 10, the real estate agent 1 or another party records the entire inspection of the property 10 showing each room and covering every detail of the property 10. The buyer 2 is able to point to fittings or other items and the seller 3, or real estate 1 agent on the seller's behalf, can confirm whether these will be included with the sale of the property thus, enabling the buyer 2 to have a record and evidence of everything which should be included and received with the property 10 when the purchase is finalised. Similarly any physical or structural abnormalities for repair can also be recorded. The recording is preferably provided in real-time as the buyer 2 is carrying out the inspection of the property 10 to ensure that the buyer 2 is aware of everything that is agreed to and to prevent changes being made without consent in between the time of agreement and time of recording. In a further embodiment of the invention, it is envisaged that the inspection and recording of the inspection may be carried out by the real estate agent 1, in the event that the buyer 2 is unable to be physically present at the inspection, and forwarded to the buyer 2 for their review via DVD, CD, video or any other suitable means such as email, an online video streaming file made available online or the like.

By providing a video and/or audio record of one or more of the property inspections, a buyer 2 is able to make a comparison between the recordings and ensure that they are still receiving everything that has been previously agreed upon and/or check that any repairs have been fixed as requested prior to the transfer of title and handover of the property 10. Following the inspection, the buyer 2 can also be provided with a report containing an itemised list of household contents and fittings which not only provides a valuable record for the buyer 2, but can be helpful for insurance or other related purposes.

The method for recording real estate transactions preferably provides that the signing of each written document be recorded with a copy of the actual document provided on the DVD whether it be video or still image of the document or a picture or scanned file being saved and viewable on the DVD and/or printable if necessary.

The buyer 2 and/or seller 3 is preferably provided with a copy of the DVD which has recorded each step of the real estate transaction and copies of all necessary documents and contracts. The originals of each of the relevant documents may of course be provided to the buyer 2 and/or seller 3 however, the DVD provides the buyer and/or seller with a quick and easy to access reference point for obtaining these documents or recalling a relevant action, to overcome the situation of not being able to locate a document or not having an agreement properly recorded to create an enforceable agreement/contract.

The method and system for recording real estate transactions ensures that the purchasing/selling of a home is a more legally sound process by recording the complete transaction including the condition of the house, property and associated contents/fittings at the time of purchase as evidence for the buyer/seller.

Whilst the invention has been described herein in terms of a method and system for recording real estate transactions which is adapted to be used in conjunction with or provided for a real estate agent, it is envisaged that the same method and system could be employed by individual buyers 2 and sellers 3 transferring a property or engaging in any other applicable transaction.

In a further embodiment, it is envisaged that the method and system for recording real estate transactions may be provided in an online environment whereby users are able to register online and have access to the recordings online. It is envisaged that the buyer will be able to log into the system and view all their recordings which are preferably uploaded by the real estate agent/seller. The recordings may preferably be in a video streaming and/or or any other suitable format which can be played using a suitable media player.

While we have described herein a particular embodiment of a method and system for recording real estate transactions, it is further envisaged that other embodiments of the invention could exhibit any number and combination of any one of the features previously described. However, it is to be understood that any variations and modifications can be made without departing from the spirit and scope thereof.

I claim:

1. A system for recording real estate transactions including:
at least one buyer and at least one seller and/or at least one real estate agent;
at least one property for sale;
at least one real estate transaction between said buyer and seller/real estate agent; and
a recording means for capturing at least one footage of said transaction whereby the system for recording real estate transactions provides a means of enabling a person to have a visual and/or audio record of all aspects of a real estate transaction.

2. A system for recording real estate transactions as claimed in claim 1 wherein the real estate agent is a qualified/registered real estate agent who has been engaged to act on behalf of a buyer and/or seller for the purchase and/or sale of a property.

3. A system for recording real estate transactions as claimed in claim 1 wherein the recording means is a recording service which is provided by the real estate agent/company or any other suitable independent company or individual capable of providing such a service.

4. A system for recording real estate transactions as claimed in claim 3 wherein the recording service has provided a recording device.

5. A system for recording real estate transactions as claimed in claim 4 wherein the recording device is in the form of a video recorder/handycam or the like which is capable of recording both audio and video formats.

6. A system for recording real estate transactions as claimed in claim 4 or claim 5 wherein the recording device is portable so that it can be taken to different locations and be unobtrusive in the recording process.

7. A system for recording real estate transactions as claimed in any preceding claim wherein the video and/or audio footage captured by the recording means and/or copies of documents is able to be recorded in a storable format onto a recordable media which enables unlimited playback of recorded material at a later stage.

8. A system for recording real estate transactions as claimed in claim 7 wherein the recordable media may be a DVD, CD, video tape or the like.

9. A system for recording real estate transactions as claimed in claim 7 wherein the footage is made available in an online environment via a website.

10. A system for recording real estate transactions as claimed in claim 7 or claim 8 wherein the footage is preferably stored in segments/chapters to enable easy navigation and retrieval of the desired footage.

11. A system for recording real estate transactions as claimed in any preceding claim having at least one report to be provided to the buyer containing an itemised list of household contents and fittings.

12. A method for recording real estate transactions comprising the following steps;
providing at least one buyer and at least one seller;
providing at least one property for sale;
providing at least one real estate transaction between said buyer and seller/real estate agent;
providing a recording means for capturing at least one footage of said transaction whereby the system for recording real estate transactions provides a means of enabling a person to have a visual and/or audio record of all aspects of a real estate transaction.

13. A method for recording real estate transactions as claimed in claim 12 wherein the entire inspection of the property is recorded showing each room and covering every detail of the property and the entire real estate transaction is recorded.

14. A method for recording real estate transactions as claimed in claim 12 or claim 13 wherein the buyer is able to have confirmation of inclusions and/or repairs and maintenance requirements recorded at each inspection.

15. A method for recording real estate transactions as claimed in claim 12 wherein the footage of the real estate transaction and/or electronic copies of any documents are recorded on a recordable media and given to the buyer and/or seller.

16. A method for recording real estate transactions as claimed in claim 12 wherein the buyer is further provided with at least one report containing an itemised list of household contents and fittings.

17. A method and system for recording real estate transactions as substantially described herein with reference to the above examples and drawing figures.
